(19) United States
(12) Patent Application Publication
(10) Pub. No.: US 2012/0011954 A1
(43) Pub. Date: Jan. 19, 2012

(54) Right Angle Drive Having Dual Shaft Bearings

(75) Inventor: Edward D. Adkins, Machesney Park, IL (US)

(73) Assignee: NOMIS LLC, Hampshire, IL (US)

(21) Appl. No.: 13/175,302

(22) Filed: Jul. 1, 2011

Related U.S. Application Data
(60) Provisional application No. 61/363,706, filed on Jul. 13, 2010.

(51) Int. Cl. F16H 1/14; F16H 1/12

(52) U.S. Cl. 74/417; 74/416

(57) ABSTRACT

A right-angle drive having dual shaft bearings is provided. The right-angle drive includes a pair of transmission assemblies that each have a shaft. Each shaft is supported by multiple bearings to enhance the load-bearing capabilities of the transmission assemblies.

CROSS-REFERENCE TO RELATED PATENT APPLICATIONS

This patent application claims the benefit of U.S. Provisional Patent Application No. 61/363,706, filed Jul. 13, 2010, the entire teachings and disclosure of which are incorporated herein by reference thereto.

### FIELD OF THE INVENTION

This invention generally relates to hand tools and more particularly to right angle drives.

### BACKGROUND OF THE INVENTION

Right angle drives are particularly useful when drilling holes in confined spaces such as inside corners and the like. Right angle drives are commonly used to transmit a driving torque from a first axis to a second axis disposed at a right angle to the first axis. These drives typically incorporate a power transmission mechanism to achieve this functionality.

A typical power transmission mechanism for a right angle drive includes a pair of shafts arranged generally perpendicular to one another. A gear is connected to one end of each shaft. The shafts are arranged such that the gears mesh. As a result, rotation of one shaft causes a like rotation in the other shaft. Each shaft is also typically supported by a bearing. The bearing is often times press fit to the shaft, and defines an outer most periphery of the shaft and bearing assembly. Each shaft carrying a gear and bearing is then installed in a housing. The housing typically has an internal cavity that houses the gears, bearings, and a portion of the shafts.

Unfortunately, if one bearing fails, the entire power transmission mechanism becomes inoperable. Disassembly of the housing, shafts, gears, and bearings is generally not an option due to the press fit between the bearing and the shaft. Moreover, in many designs the bearings are press fit into the housing after they have been press fit onto the shaft thereby making disassembly even more difficult. As such, bearing failure can often times render an entire right angle drive inoperable and necessitate the replacement of the same.

In view of the above, there is a need in the art for a right angle drive that has a heightened resistance to bearing failure. Embodiments of the invention provides such a right angle drive. These and other advantages of the invention, as well as additional inventive features, will be apparent from the description of the invention provided herein.

### BRIEF SUMMARY OF THE INVENTION

In view of the above, embodiments of the present invention provide a right-angle drive with dual shaft bearings that overcome existing problems in the art. More particularly, embodiments of the present invention provide a new and improved right-angle drive having enhanced bearing failure resistance by incorporating transmission shafts supported by multiple bearings.

In one embodiment, a right-angle drive is provided. The right-angle drive includes at least one shaft configured to transmit an input torque to an output end of the right-angle drive. The at least one shaft has a gear portion and a bearing portion. The gear portion extends away from the bearing portion and terminates at an end of the shaft. The bearing portion has a length greater than a length of the gear portion. At least one bearing is mounted to the at least one shaft on the bearing portion thereof and radially supports the shaft.

In another embodiment, the gear portion has a first diameter and the bearing portion has a second diameter, wherein the first diameter less than the second diameter.

In another embodiment, the right-angle drive further includes a housing. The at least one bearing has an outer periphery that defines a bearing support region. The bearing support region contacts an internal cavity of the housing. The bearing portion and gear portion of the at least one shaft are internally disposed within the cavity of the housing.

In another embodiment, the bearing support region extends a length greater than 50% of the length of the bearing portion. In another embodiment, the bearing support region extends a length greater than 75% of the length of the bearing portion. In another embodiment, the bearing support region extends a length greater than 90% of the length of the bearing portion.

In another embodiment, a right-angle drive is provided. The right-angle drive includes at least one shaft operable to transfer an input torque from a first end of the right-angle drive to a second end of the right-angle drive. The at least one shaft has an abutment. At least one bearing is carried by and regularly supports the shaft. The at least one bearing is in abutted contact with the abutment. The at least one bearing has an outer periphery providing a bearing region that has a first axial length. The bearing region extends axially away from the abutment. A first gear is carried by the shaft and is operable to mesh with a second gear at a mesh point. The mesh point is axially spaced away from the abutment at a second axial length. The bearing region extends between the abutment and the gear. A bearing support ratio is defined by the first axial length relative to the second axial length.

In another embodiment, the bearing support ratio is greater than about 0.5 to about 1. In another embodiment, the bearing support ratio is greater than about 0.65 to about 1. In another embodiment, the bearing support ratio is greater than about 0.75 to about 1.

In another embodiment, a right-angle drive is provided. The right-angle drive includes a first shaft having an abutment and a second shaft also having an abutment. A first gear is mounted to the first shaft. A second gear is mounted to the second shaft, and the gears mesh to operably transfer an input torque between the first and second shafts. A plurality of bearings support the first shaft between the abutment of the first shaft and the first gear. Similarly, a plurality of bearings support the second shaft between the abutment of the second shaft and the second gear.

In another embodiment, each one of the first plurality of bearings extends away from the abutment beginning with a first one of the plurality of bearings in abutted contact with the abutment of the first shaft and ending at a last one of the first plurality of bearings axially spaced the farthest away from the abutment of the first shaft. Each one of the second plurality of bearings extends away from the abutment beginning with a first one of the first plurality of bearings in abutted contact with the abutment of the second shaft and ending at a last one of the second plurality of bearings axially spaced the farthest away from the abutment of the second shaft.

In another embodiment, a first number of bearings of the first plurality of bearings is equal to a second number of bearings of the second plurality of bearings. In another embodiment, the first number of bearings is at least two bearings.

In another embodiment, the first and second shafts each have a connection region, a load-bearing region, and a radially outwardly extending flange separating the connection region and the load-bearing region. The abutment of the first shaft is provided by the flange of the first shaft and the abutment of the second shaft is provided by the flange of the second shaft.

In another embodiment, the load-bearing region of each of the first and second shafts has a gear portion and a bearing portion. The first plurality of bearings are mounted to the gear portion of the first shaft. The second plurality of bearings are mounted to the gear portion of the second shaft.

In another embodiment, the gear portion of the first shaft has an axial length shorter than an axial length of the bearing portion of the first shaft. The gear portion of the second shaft has an axial length shorter than an axial length of the bearing portion of the second shaft.

In another embodiment, the gear portion of the first shaft has a diameter less than a diameter of the bearing portion of the first shaft. The gear portion of the second shaft has a diameter less than a diameter of the bearing portion of the second shaft. In another embodiment, the flange of the first shaft has a diameter greater than the diameters of the gear and bearing portions of the first shaft. The flange of the second shaft has a diameter greater than the diameters of the gear and bearing portions of the second shaft.

In another embodiment, the connection region of the first shaft is operably coupled to an input shaft for providing the input torque. The connection region of the second shaft is operably coupled to a chuck of the right-angle drive.

In another embodiment, an angle drive attachment is provided. The angle drive attachment according to this embodiment includes a housing and an input shaft. A pair of input bearings are rotatably mounted to the input shaft within the housing for rotation about an input axis. The angle drive attachment further includes an output shaft. A pair of output bearings are rotatably mounted to the output shaft within the housing for rotation about an output axis that is non-parallel to the input axis. The input shaft is operably coupled to the output shaft to transmit torque there between.

In another embodiment, the angle drive further includes an input gear attached to a cantilevered portion of the input shaft. The angle drive also includes an output gear mating with the input gear and attached to a cantilevered portion of the output shaft. In another embodiment, the input and output gears are bevel gears.

In another embodiment, the input bearings are at different axial locations along the input axis and the output bearings are at different axial locations along the output axis. In another embodiment, the input bearings axially abut and the output bearings axially abut. In another embodiment, the input bearings are axially spaced apart along the input axis and the output bearings are axially spaced apart along the output axis. In another embodiment, the input and output axes are perpendicular.

In another embodiment, the housing includes an input abutment and the input shaft includes an input shaft abutment. The input bearings are axially positioned between the input abutment and the input shaft abutment. One bearing contacts the input abutment and one bearing contacts the input shaft abutment. In another embodiment, the bearings include a roller element.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an exemplary embodiment of a right-angle drive according to the teachings of the present invention, connected to a power drill;

FIG. 2 is an exploded perspective view of the right-angle drive of FIG. 1;

FIG. 3 is a side cross-sectional view of a first shaft of the right-angle drive of FIG. 1;

FIG. 4 is a side cross-sectional view of a second shaft of the right-angle drive of FIG. 1;

FIG. 5 is a side cross-sectional view of the shaft of FIG. 3 with a pair of bearings and a gear mounted thereon;

FIG. 6 is a side cross-sectional view of the shaft of FIG. 4 with a pair of bearings and a gear mount thereon; and

FIG. 7 is a side cross-sectional view of the right-angle drive of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

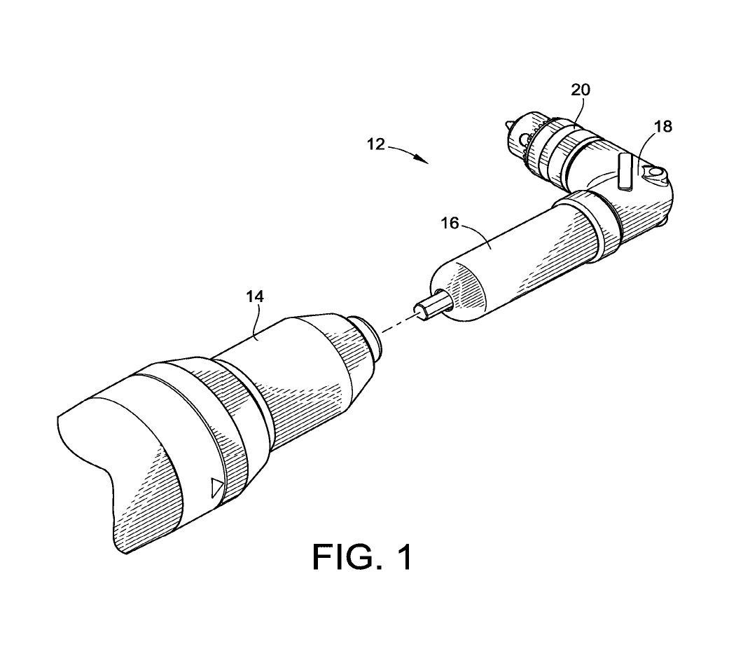

Turning now to the drawings, there is illustrated in FIG. 1, a right-angle drive 12 connected to a drill 14. While the following description will reference the advantages and benefits of the right-angle drive 12 in combination with a typical drill 14 (e.g. a power drill), it is recognized that the right-angle drive 12 may be utilized in other applications such as milling or manual processes.

The right-angle drive 12 has a handle 16 connected to one end of an elbow 18. A chuck 20 is connected to an opposite end of the elbow 18. As such, a center axis of the chuck 20 is generally 90 degrees relative to a center axis of the handle 16.

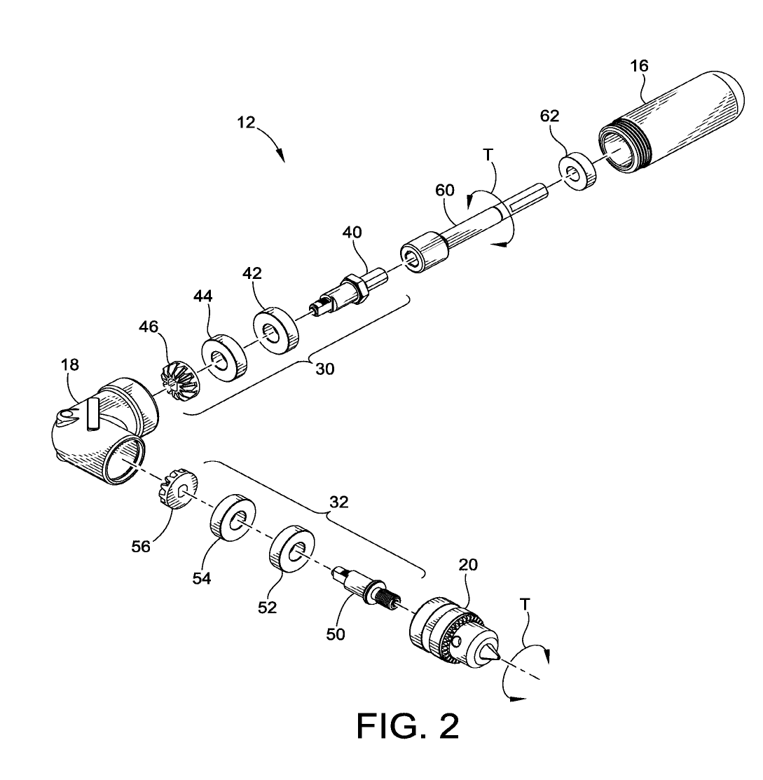

Turning now to FIG. 2, the right-angle drive 12 has first and second transmission assemblies 30, 32. The first and second transmission assemblies 30, 32 are mechanically connected and operable to transmit a torque from an input shaft 60 to the chuck 20. As will be discussed in greater detail below, the right angle drive 12 is operable to transmit an input torque supplied by the drill 14 to the chuck 20.

The right angle drive 12 has first and second transmission assemblies 30, 32. The first transmission assembly 30 has a shaft 40, a pair of bearings 42, 44, and a gear 46. The bearings 42, 44 and gear 46 are a affixed to the shaft 40. The gear 46 is affixed such that is does not rotate relative to the shaft 40.

Similarly, the second transmission assembly 32 has a shaft 50, a pair of bearings 52, 54, and a gear 56. The bearings 52, 54 and gear 56 are affixed to the shaft 50. The gear 56 is affixed such that it does not rotate relative to the shaft 50. The type and number of bearings used in the first transmission assembly 30 may be the same or different from that used in the second transmission assembly 32.

The gears 46, 56 mesh internally within the elbow 18 which forms a gear housing. The shaft 40 of the first transmission assembly 30 is radially supported by the bearings 42, 44 internally within the elbow 18. Similarly, the shaft 50 of the second transmission assembly 32 is radially supported by the bearings 52, 54 of the second transmission assembly 32 within the elbow 18.

The use of multiple bearings to support each shaft 40, 50 results in better load distribution throughout the first and second transmission assemblies 30, 32 such that the right-angle drive 12 has a longer service life than prior designs. More particularly, using multiple bearings to support each shaft 40, 50 reduces the likelihood of failure of any one of the bearings supporting the same, or the shafts 40, 50.

In a preferred embodiment, the bearings 42, 44, 52, 54 are rolling element bearings. However, in other embodiments, they could be other types of bearings, or bushings.

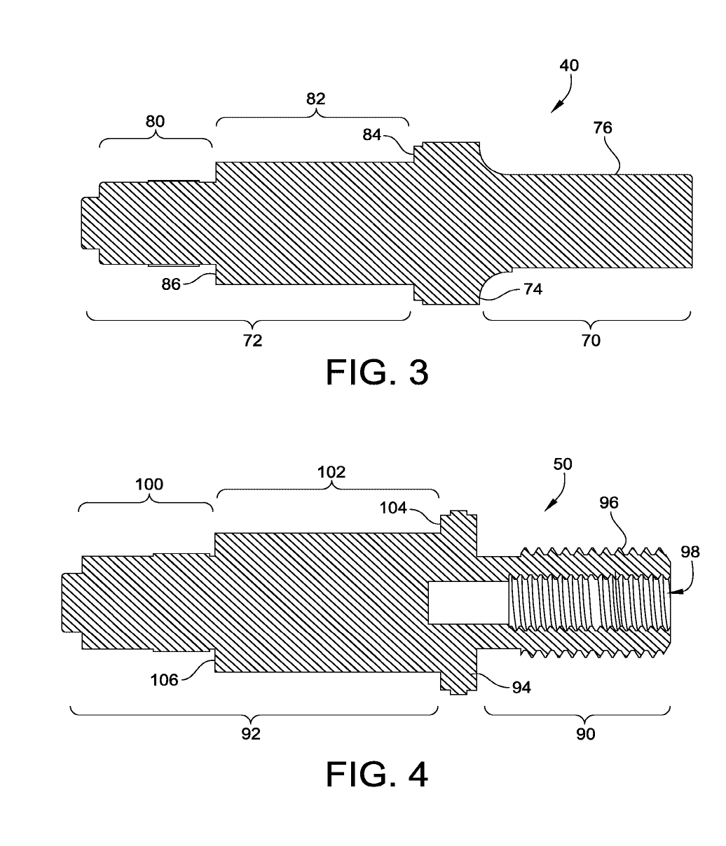

With reference now to FIG. 3, the shaft 40 of the first transmission assembly (see FIG. 2) has a connection region 70 and a load-bearing region 72 separated by a flange 74. The connection region 70 connects to the input shaft 60 of the right-angle drive (see FIG. 2). The connection region 70 of the shaft 40 has an outer periphery 76. The shape of the outer periphery 76 is defined by a cross-sectional profile of the shaft 40 in the connection region 70. The profile can be round, hexagonal, triangular, or other profiles commonly used in the connection of rotational mechanisms.

The load-bearing region 72 of the shaft 40 has a gear portion 80 for receiving the gear 46 (see FIG. 2) in abutted contact with a gear abutment surface 86 of the shaft 40. The load-bearing region 72 also has a bearing portion 82 for receiving the bearings 42, 44 (see FIG. 2), with one bearing 42 in abutted contact with an abutment surface 84 (see FIG. 2). In the illustrated embodiment, the abutment surface 84 is provided by the flange 74.

With reference to FIG. 4, the shaft 50 of the second transmission assembly 32 also has a connection region 90 and a load-bearing region 92 separated by a flange 94. The connection region 90 has a threaded outer periphery 96 to receive the chuck 20 (see FIG. 1). The connection region 90 also has a threaded hole 98, also used for mounting the chuck 20 (see FIG. 1) to the shaft 50.

The load-bearing region 92 has a gear portion 100 and a bearing portion 102. The gear 56 of the second transmission assembly 32 (see FIG. 2) mounts to the gear portion 100 in abutted contact with a gear abutment surface 106 of the shaft 50. The bearings 52, 54 of the second transmission assembly (see FIG. 2) mount to the bearing portion 102, with one bearing 52 in abutted contact with a bearing abutment surface 104 of the flange 94 of the shaft 50.

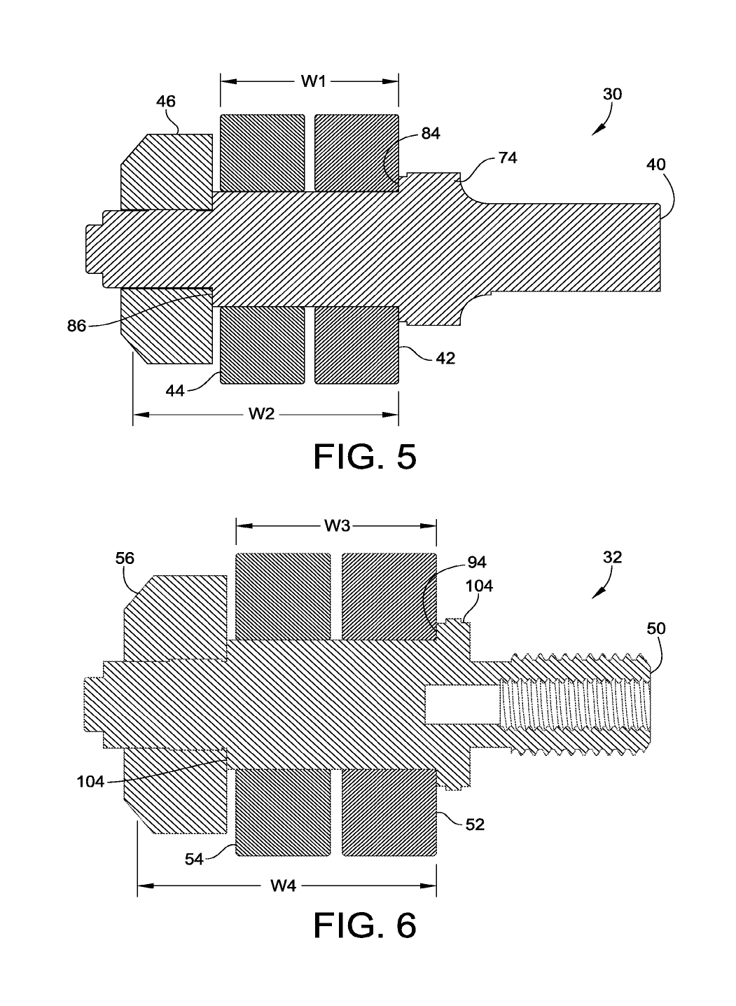

With reference to FIG. 5, the bearings 42, 44 of the first transmission 30 (see FIG. 2) are illustrated mounted on the shaft 40. The bearings 42, 44 can be mounted on the shaft 40 using a press fit to insure sufficient contact of the shaft 40 relative to the bearings 42, 44. The bearings 42, 44 can be embodied as a variety of rolling element bearings such as ball bearings, roller bearings, needle bearings, or even bushings. Additionally, each one of the bearings 42, 44 may be different or the same type of bearing as each other one of the bearings 42, 44.

When mounted to the shaft 40, the bearings 42, 44 can abut against one another or be spaced apart with one bearing 42 abutting against the abutment surface 84 of the shaft 40. When installed as illustrated, the bearings provide a bearing support region taken from the abutment surface 84 to an outer edge of the bearing 44 farthest away from the abutment surface 84 and having a width denoted as W1.

The gear 56 of the first transmission assembly 30 is also illustrated mounted to the shaft 40. The gear 56 may be mounted to the shaft 40 using a press fit to insure sufficient contact between the shaft 40 and the gear 56. The gear 46 may be a bevel gear or other gear typically used to transfer torque between non-parallel axes.

A distance from a mesh point of the gear 46 to the abutment surface 84 is denoted as width W2. The ratio of W1 to W2 can be used to characterize the enhanced load-bearing capabilities of the first transmission mechanism 30. In one embodiment, this ratio is about 0.5 to 1. More preferably, this ratio is about 0.65 to 1. Still more preferably, this ratio is about 0.75 to 1.

The width W1 relative to the total width of the bearing portion 82 (see FIG. 3) can also be used to characterize the enhanced load-bearing capabilities of the first transmission assembly 30. In one embodiment, the width W1 of the bearings 42, 44 taken from the abstract surface 84 is greater than 50% of the width of the bearing portion 82 (see FIG. 3). More preferably, the width W1 of the bearings 42, 44 taken from the abutment surface is greater than 75% of the width of the bearing portion 82 (see FIG. 3). Still more preferably, the width W1 of the bearings 42, 44 taken from the abutment surface 84 is greater than 90% of the width of the bearing portion 82 (see FIG. 3).

Turning now to FIG. 6, in a similar manner as that discussed above with respect to FIG. 5, the bearings 52, 54 of the second transmission assembly 32 can be press fit to the shaft 50. The bearings 52, 54 may be embodied as various rolling element type bearings such as ball bearings, roller bearings, needle bearings, or bushings, etc. Additionally, each one of the bearings 52, 54 may be different or the same type of bearing as each other one of the bearings 52, 54.

When installed, the bearings 52, 54 define a bearing support region that extends from the abutment surface 104 out to the outermost edge of the bearing 54 farthest away from the abutment surface 104 and denoted by width W3.

The gear 56 can be mounted to the shaft 50 also using a press fit to insure sufficient contact between the gear 56 and the shaft 50. A distance from the abutment surface 104 out to a meshing point of the gear 56 is denoted as width W4. As was the case with the first transmission assembly 30 discussed above with reference to FIG. 5, the ratio between widths W3 and W4 can be used to characterize the enhanced load-bearing capabilities of the second transmission assembly 32. In one embodiment, this ratio is preferably 0.5 to 1. More preferably, this ratio is 0.65 to 1. Still more preferably, this ratio is about 0.75 to 1.

The width W2 relative to the total width of the bearing portion 102 (see FIG. 4) can also be used to characterize the enhanced load-bearing capabilities of the second transmission assembly 32. In one embodiment, width W2 of the bearings 52, 54 taken from the abstract surface 104 is greater than 50% of the width of the bearing portion 102 (see FIG. 4). More preferably, the width W2 of the bearings 52, 54 taken from the abutment surface is greater than 75% of the width of the bearing portion 102 (see FIG. 4). Still more preferably, the width W2 of the bearings 52, 54 taken from the abutment surface 104 is greater than 90% of the width of the bearing portion 102 (see FIG. 4).

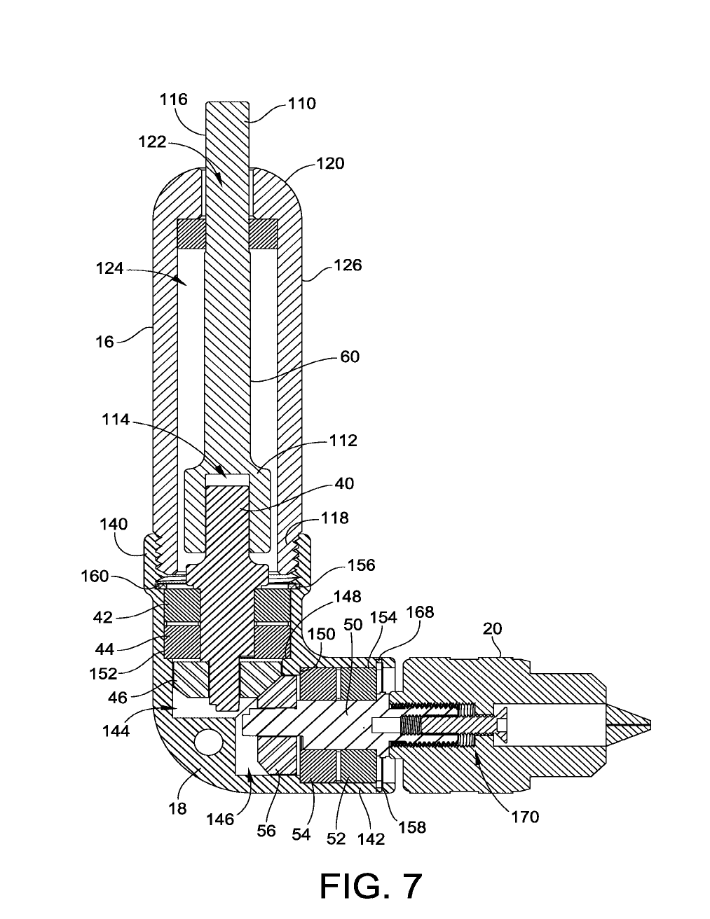

Turning now to FIG. 7, the input shaft 60 is used to transmit a torque through the first and second transmission assemblies 30, 32 (see FIG. 2) to the chuck 20. The input shaft 60 has a first end 110 and a second end 112. The first end 110 has an outer peripheral surface 116. The outer peripheral surface 116 is defined by a cross-sectional profile that can be straight, hexagonal, triangular, or any other profile commonly used in rotational mechanisms. The second end 112 has an opening 114 therein. The opening 114 is used to connect the input shaft 60 to the connection region (see FIG. 3) of the shaft 40 of the first transmission assembly 30 (see FIG. 2).

The handle 16 has a first end 118 and a second end 120. The second end 120 has a bore 122 passing therethrough to allow the first end 110 of the input shaft 60 to extend from the handle 16 for connection to a drill 14 (see FIG. 1) or similar device. The first end 118 is threaded for connecting the handle 16 to the elbow 18. The remainder of the input shaft 60 is disposed within a cavity 124 of the handle 16. As illustrated in FIG. 7, the cavity 124 of the handle 16 also carries an input bearing 62 that support the input shaft 60. Also, as illustrated in FIG. 7, the connection between the shaft 40 of the first transmission assembly 30 (see FIG. 2) and the input shaft 60 occurs within the cavity 124 of the handle 16.

The handle 16 also has an outer peripheral surface 126. The outer peripheral surface 126 can be smooth or include other surface features such as finger indentations, gratings, rubberized grips, etc. Additionally, the handle 16 is generally interchangeable with other handles by removing the handle 16 from the elbow 18 and replacing it with a different handle.

The elbow 18 has a first end 140 and second end 142. The first end threadably receives the handle 16. The chuck 20 mounts to the shaft 50 of the second transmission assembly 32 (see FIG. 2) proximate the second end 142 of the elbow 18.

The elbow 18 has first and second cavities 144, 146 internally therein. The first and second cavities 144, 146 are in communication with one another. The gear 46 and bearings 42, 44 of the first transmission assembly 30 (see FIG. 2) are disposed within the first cavity 144. The gear 56 and bearings 52, 54 of the second transmission assembly 32 (see FIG. 2) are disposed within the second cavity 146. The gears 46, 56 mesh at the union of the first and second cavities 144, 146.

The first cavity 144 has an abutment surface 148 that the bearing 44 farthest away from the abutment 84 of the shaft 40 of the first transmission assembly 30 (see FIG. 2) abuts against. When fully installed, the bearings 42, 44 are in surface contact with a bearing surface 152 having a similar width as width W3 of the FIG. 5. The bearings 42, 44 may be installed within the first cavity 144 by a press fit to insure sufficient engagement with the first cavity 144. Additionally, the first cavity 144 can also include a groove 156 for receipt of a retainer ring 160 to insure the bearings 42, 44 are sufficiently retained within the first cavity 144.

The second cavity 146 also has an abutment surface 150. The bearings 54, 56 of the second transmission assembly 32 (see FIG. 2) abut against the abutment 150 of the second cavity 146. When fully installed, the bearings 54, 56 are in contact with a bearing surface 152 of the second cavity 146. The bearing surface 154 has a substantially similar length as width W3 of FIG. 6. The bearings 54, 56 may be press fit within the second cavity 146 to insure sufficient engagement with the elbow 18. Additionally, the second cavity 146 can also include a groove 158 that receives a retainer ring 168 to aid in retaining the second transmission assembly 32 (see FIG. 2) within the second cavity 146.

The connection region 90 (see FIG. 4) extends from the second end 142 of the elbow 18. The chuck 20 has a threaded bore 170 to threadably engage the connection region 90 of shaft 50.

As described herein, embodiments of the invention provide a right-angle drive 12 that incorporates first and second transmission assemblies 30, 32 that have enhanced load-bearing capabilities over prior designs by incorporating multiple bearings for each shaft 40, 50 of each transmission assembly 30, 32. By incorporating multiple bearings per shaft, the bearings have a longer life span such that the right-angle drive 12 has a longer life span than prior designs.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A right angle drive, comprising:
at least one shaft configured to transmit an input torque to an output end of the right angle drive, the at least one shaft having a gear portion and a bearing portion, the gear portion extending away from the bearing portion and terminating at an end of the shaft, the bearing portion having a length greater than a length of the gear portion; and
at least one bearing mounted to the at least one shaft on the bearing portion and radially supporting the shaft.

2. The right angle drive of claim 1, wherein the gear portion has a first diameter and the bearing portion has a second diameter, the first diameter less than the second diameter.

3. The right angle drive of claim 1, further comprising a housing, wherein the at least one bearing has an outer periphery that defines a bearing support region, the bearing support region contacting an internal cavity of the housing, the bearing portion and gear portion of the at least one shaft internally disposed within the cavity of the housing.

4. The right angle drive of claim 3, wherein the bearing support region extends a length greater than 50% of the length of the bearing portion.

5. The right angle drive of claim 3, wherein the bearing support region extends a length greater than 75% of the length of the bearing portion.

6. The right angle drive of claim 3, wherein the bearing support region extends a length greater than 90% of the length of the bearing portion.

7. A right angle drive, comprising:
at least one shaft operable to transfer an input torque from a first end of the right angle drive to a second end of the right angle drive, the at least one shaft having an abutment;
at least one bearing carried by and radially supporting the shaft and in abutted contact with the abutment, the at least one bearing having an outer periphery providing a bearing region having a first axial length, the bearing region extending axially away from the abutment;
a first gear carried by the shaft and operable to mesh with a second gear at a mesh point, the mesh point axially spaced away from the abutment at a second axial length; and
wherein the bearing region extends between the abutment and the gear, and wherein a bearing support ratio is defined by the first axial length relative to the second axial length.

8. The right angle drive of claim 7, wherein the bearing support ratio is greater than about 0.5 to about 1.

9. The right angle drive of claim 7, wherein the bearing support ratio is greater than about 0.65 to about 1.

10. The right angle drive of claim 7, wherein the bearing support ratio is greater than about 0.75 to about 1.

11. A right angle drive, comprising:
a first shaft having an abutment;
a second shaft having an abutment;
a first gear mounted to the first shaft;
a second gear mounted to the second shaft, the gears meshing to operably transfer an input torque between the first and the second shafts;
a first plurality of bearings supporting the first shaft between the abutment of the first shaft and the first gear; and
a second plurality of bearings supporting the second shaft between the abutment of the second shaft and second gear.

12. The right angle drive of claim 11, wherein each one of the first plurality of bearings extends away from the abutment beginning with a first one of the first plurality of bearings in abutted contact with the abutment of the first shaft and ending at a last one of the first plurality of bearings axially spaced the farthest away from the abutment of the first shaft, and wherein each one of the second plurality of bearings extends away from the abutment beginning with a first one of the second plurality of bearings in abutted contact with the abutment of the second shaft and ending at a last one of the second plurality of bearings axially spaced the farthest away from the abutment of the second shaft.

13. The right angle drive of claim 12, wherein a first number of bearings of the first plurality of bearings is equal to a second number of bearings of the second plurality of bearings.

14. The right angle drive of claim 13, wherein the first number of bearings is at least two bearings.

15. The right angle drive of claim 14, wherein the first and the second shafts each have a connection region, a load bearing region, and a radially outwardly extending flange separating the connection region and the load bearing region, wherein the abutment of the first shaft is provided by the flange of the first shaft and the abutment of the second shaft is provided by the flange of the second shaft.

16. The right angle drive of claim 15, wherein the load bearing region of each of the first and second shafts has a gear portion and a bearing portion, and wherein the first plurality of bearings are mounted to the gear portion of the first shaft and the second plurality of bearings are mounted to the gear portion of the second shaft.

17. The right angle drive of claim 16, wherein the gear portion of the first shaft has an axial length shorter than an axial length of the bearing portion of the first shaft, and wherein the gear portion of the second shaft has an axial length shorter than an axial length of the bearing portion of the second shaft.

18. The right angle drive of claim 17, wherein the gear portion of the first shaft has a diameter less than a diameter of the bearing portion of the first shaft, and wherein the gear portion of the second shaft has a diameter less than a diameter of the bearing portion of the second shaft.

19. The right angle drive of claim 18, wherein the flange of the first shaft has a diameter greater than the diameters of the gear and bearing portions of the first shaft, and wherein the flange of the second shaft has a diameter greater than the diameters of the gear and bearing portions of the second shaft.

20. The right angle drive of claim 19, wherein the connection region of the first shaft is operably coupled to an input shaft providing the input torque, and the connection region of the second shaft is operably coupled to a chuck of the right angle drive.

21. An angle drive attachment comprising:
a housing
an input shaft;
a pair of input bearings rotatably mounting the input shaft within the housing for rotation about an input axis;
an output shaft;
a pair of output bearings rotatably mounting the output shaft within the housing for rotation about an output axis that is non parallel to the input axis, the input shaft operably coupled to the output shaft to transmit torque therebetween.

22. The angle drive attachment of claim 21, further including an input gear attached to a cantilevered portion of the input shaft and an output gear mating with the input gear and attached to a cantilevered portion of the output shaft.

23. The angle drive attachment of claim 22, wherein the input and output gears are bevel gears.

24. The angle drive attachment of claim 21, wherein the input bearings are at different axial locations along the input axis and the output bearings are at different axial locations along the output axis.

25. The angle drive attachment of claim 24, wherein the input bearings axially abut and the output bearings axially abut.

26. The angle drive attachment of claim 24, wherein the input bearings are axially spaced apart along the input axis and the output bearings are axially spaced apart along the output axis.

27. The angle drive attachment of claim 21, wherein the input and output axes are perpendicular.

28. The angle drive attachment of claim 21, wherein the housing includes an input abutment and the input shaft includes an input shaft abutment, the input bearings axially positioned between the input abutment and the input shaft abutment, one bearing contacting the input abutment and one bearing contacting the input shaft abutment.

29. The angle drive attachment of claim 21, wherein the bearings include a roller element.
